(19) United States
(12) Patent Application Publication
(10) Pub. No.: US 2019/0276027 A1
(43) Pub. Date: Sep. 12, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Akihiro Toda, Wako-shi (JP)

(21) Appl. No.: 16/291,029

(22) Filed: Mar. 4, 2019

(30) Foreign Application Priority Data
Mar. 7, 2018 (JP) 2018-041266

(51) Int. Cl. B60W 30/18; B60W 30/12; B60W 40/04; B60W 40/105

(52) U.S. Cl. CPC B60W 30/18163; B60W 40/105; B60W 40/04; B60W 30/12

(57) ABSTRACT

A vehicle control device includes a congestion state determiner (132) that determines whether or not a plurality of preceding vehicles, which are present ahead of an own-vehicle in an own lane in which the own-vehicle is traveling, are in a congested state on the basis of a recognition result of a recognizer that recognizes at least one of a surrounding environment of the own-vehicle or a traveling speed of the own-vehicle, and a driving controller (140, 160) that controls at least steering of the own-vehicle and causes the own-vehicle to travel toward an added lane from the own lane at a position before a start position of the added lane if a condition including that the own-vehicle be scheduled to move from the own lane to the added lane to travel along a target route and that the congestion state determiner have determined that the preceding vehicles are in a congested state is satisfied.

### CROSS-REFERENCE TO RELATED APPLICATION

Priority is claimed on Japanese Patent Application No. 2018-041266, filed Mar. 7, 2018, the content of which is incorporated herein by reference.

### BACKGROUND

### Field of the Invention

The present invention relates to a vehicle control device, a vehicle control method, and a storage medium.

### Description of Related Art

In recent years, research on automatic control of the driving of a vehicle (hereinafter referred to as automated driving) has been conducted. On the other hand, for example, a navigation device that, if a right-turn only lane is congested at an intersection where a vehicle is scheduled to turn right, performs lane change guidance in advance such that the vehicle can arrive at the tail end of the congested traffic is known (for example, see Japanese Unexamined Patent Application, First Publication No. 2009-25235).

### SUMMARY

However, with the technology of the related art, it is not possible to determine whether to come close to the tail end of the congested traffic or to overtake the congested traffic. Accordingly, for example, when a vehicle is being automatically driven in a state in which a straight-ahead lane is congested and a right-turn only lane is not congested, the vehicle may come close to the tail end of the congested traffic even in a situation in which it may overtake a preceding vehicle. Thus, appropriate traveling according to surrounding traffic situations is sometimes not possible.

Aspects of the present invention have been made in view of such circumstances and it is an object of the present invention to provide a vehicle control device, a vehicle control method, and a storage medium which can realize appropriate traveling according to surrounding traffic situations.

A vehicle control device, a vehicle control method, and a storage medium according to the present invention adopt the following configurations.

(1) A vehicle control device according to an aspect of the present invention includes a congestion state determiner configured to determine whether or not a plurality of preceding vehicles, which are present ahead of an own-vehicle in an own lane in which the own-vehicle is traveling, are in a congested state on the basis of a result of recognition by a recognizer configured to recognize at least one of a surrounding environment of the own-vehicle or a traveling speed of the own-vehicle, and a driving controller configured to control at least steering of the own-vehicle and to cause the own-vehicle to travel toward an added lane from the own lane at a position before a start position of the added lane if a condition including that the own-vehicle be scheduled to move from the own lane to the added lane to travel along a target route and that the congestion state determiner have determined that the preceding vehicles are in a congested state is satisfied.

(2) In the above aspect (1), the condition further includes that the recognizer configured to recognize a surrounding situation of the own-vehicle have recognized that a traffic signal installed at an intersection relating to the added lane indicates that it is possible to proceed to a travel destination of the added lane.

(3) In the above aspect (1), the condition further includes that the recognizer configured to recognize a surrounding situation of the own-vehicle have recognized that the added lane has a space which the own-vehicle can enter.

(4) In the above aspect (1), the condition further includes that the recognizer configured to recognize a surrounding situation of the own-vehicle have recognized that there is no oncoming vehicle traveling in an opposite lane extending to a rear side of the added lane.

(5) In the above aspect (1), the condition further includes that the own-vehicle have arrived at a position from which a distance to the start position is equal to or less than a predetermined distance.

(6) A vehicle control method according to an aspect of the present invention includes an in-vehicle computer determining whether or not a plurality of preceding vehicles, which are present ahead of an own-vehicle in an own lane in which the own-vehicle is traveling, are in a congested state on the basis of a result of recognition by a recognizer configured to recognize at least one of a surrounding environment of the own-vehicle or a traveling speed of the own-vehicle, and causing the own-vehicle to travel toward an added lane from the own lane at a position before a start position of the added lane if a condition including that the own-vehicle be scheduled to move from the own lane to the added lane to travel along a target route and that it have been determined that the preceding vehicles are in a congested state is satisfied.

(7) A storage medium according to an aspect of the present invention is a computer readable non-transitory storage medium storing a program causing an in-vehicle computer to determine whether or not a plurality of preceding vehicles, which are present ahead of an own-vehicle in an own lane in which the own-vehicle is traveling, are in a congested state on the basis of a result of recognition by a recognizer configured to recognize at least one of a surrounding environment of the own-vehicle or a traveling speed of the own-vehicle, and to cause the own-vehicle to travel toward an added lane from the own lane at a position before a start position of the added lane if a condition including that the own-vehicle be scheduled to move from the own lane to the added lane to travel along a target route and that it have been determined that the preceding vehicles are in a congested state is satisfied.

According to the above aspects (1) to (7), it is possible to realize appropriate traveling according to surrounding traffic situations.

### BRIEF DESCRIPTION OF THE DRAWINGS

FIG. 1 is a configuration diagram of a vehicle system using a vehicle control device according to a first embodiment.

FIG. 2 is a functional configuration diagram of a first controller and a second controller.

FIG. 3 is a diagram illustrating an exemplary scenario in which a predetermined condition is established in the first embodiment.

FIG. 4 is a flowchart showing an example of the flow of a series of processes performed by the automated driving control device according to the first embodiment.

FIG. 5 is a diagram illustrating an exemplary scenario in which a predetermined condition is established in a second embodiment.

FIG. 6 is a diagram illustrating an exemplary scenario in which a predetermined condition is established in a third embodiment.

FIG. 7 is a diagram illustrating an exemplary scenario in which a predetermined condition is established in a fourth embodiment.

FIG. 8 is a diagram illustrating an exemplary scenario in which a predetermined condition is established in a fifth embodiment.

FIG. 9 is a diagram showing an example of the hardware configuration of an automated driving control device according to an embodiment.

### DESCRIPTION OF EMBODIMENTS

Hereinafter, embodiments of a vehicle control device, a vehicle control method, and a storage device of the present invention will be described with reference to the drawings. The following description will be given with reference to the case in which left-hand traffic laws are applied, but the terms “left” and “right” simply need to be read in reverse when right-hand traffic laws are applied.

### First Embodiment

### [Overall Configuration]

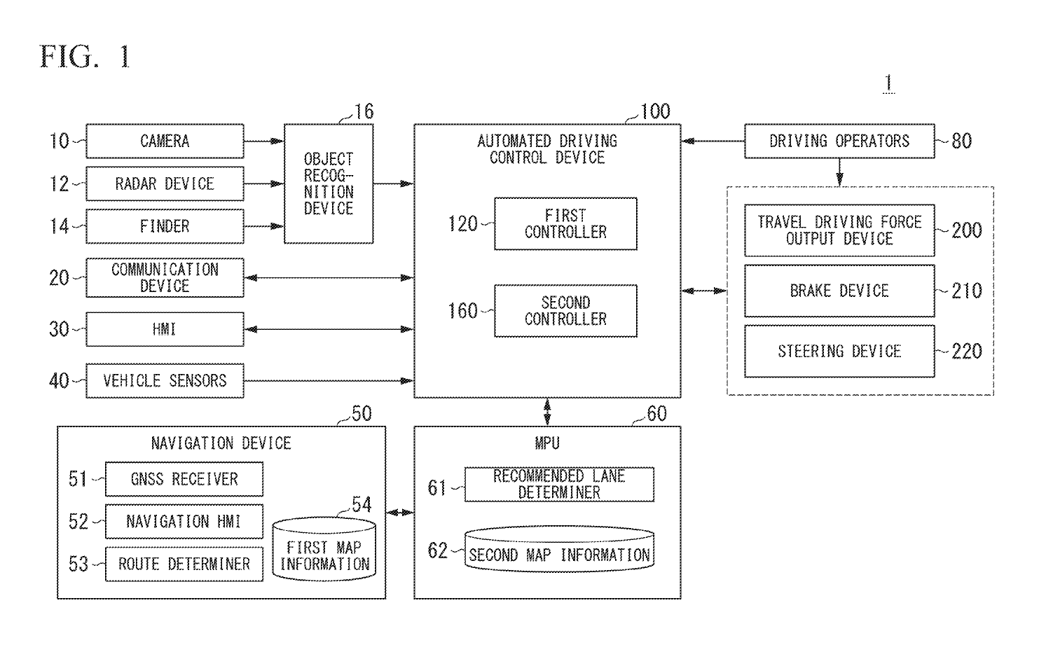

FIG. 1 is a configuration diagram of a vehicle system 1 using a vehicle control device according to a first embodiment. A vehicle in which the vehicle system 1 is mounted (hereinafter referred to as an own-vehicle M) is, for example, a vehicle such as a two-wheeled vehicle, a three-wheeled vehicle, or a four-wheeled vehicle, and a driving source thereof includes an internal combustion engine such as a diesel engine or a gasoline engine, an electric motor, or a combination thereof. The electric motor operates using electric power generated by a generator connected to the internal combustion engine or using discharge power of a secondary battery or a fuel cell.

The vehicle system 1 includes, for example, a camera 10, a radar device 12, a finder 14, an object recognition device 16, a communication device 20, a human machine interface (HMI) 30, vehicle sensors 40, a navigation device 50, a map positioning unit (MPU) 60, driving operators 80, an automated driving control device 100, a travel driving force output device 200, a brake device 210, and a steering device 220. These devices or apparatuses are connected to each other by a multiplex communication line or a serial communication line such as a controller area network (CAN) communication line, a wireless communication network, or the like. The components shown in FIG. 1 are merely an example and some of the components may be omitted or other components may be added.

The camera 10 is, for example, a digital camera using a solid-state imaging device such as a charge coupled device (CCD) or complementary metal oxide semiconductor (CMOS) image sensor. The camera 10 is attached to the own-vehicle M at an arbitrary location. For imaging the area in front of the vehicle, the camera 10 is attached to an upper portion of a front windshield, a rear surface of a rearview mirror, or the like. For example, the camera 10 repeats imaging of the surroundings of the own-vehicle M at regular intervals. The camera 10 may also be a stereo camera.

The radar device 12 radiates radio waves such as millimeter waves around the own-vehicle M and detects radio waves reflected by an object (reflected waves) to detect at least the position (distance and orientation) of the object. The radar device 12 is attached to the own-vehicle M at an arbitrary location. The radar device 12 may detect the position and velocity of an object using a frequency modulated continuous wave (FM-CW) method.

The finder 14 is a light detection and ranging (LIDAR) finder. The finder 14 illuminates the surroundings of the own-vehicle M with light and measures scattered light. The finder 14 detects the distance to a target on the basis of a period of time from when light is emitted to when light is received. The light radiated is, for example, pulsed laser light. The finder 14 is attached to the own-vehicle M at an arbitrary location.

The object recognition device 16 performs a sensor fusion process on results of detection by some or all of the camera 10, the radar device 12, and the finder 14 to recognize the position, type, speed, or the like of the object. The object recognition device 16 outputs the recognition result to the automated driving control device 100. The object recognition device 16 may output detection results of the camera 10, the radar device 12 and the finder 14 to the automated driving control device 100 as they are. The object recognition device 16 may be omitted from the vehicle system 1.

For example, the communication device 20 communicates with other vehicles near the own-vehicle M using a cellular network, a Wi-Fi network, Bluetooth (registered trademark), dedicated short range communication (DSRC) or the like or communicates with various server devices via wireless base stations.

The HMI 30 presents various types of information to an occupant in the own-vehicle M and receives an input operation from the occupant. The HMI 30 includes various display devices, a speaker, a buzzer, a touch panel, switches, keys, or the like.

The vehicle sensors 40 include a vehicle speed sensor that detects the speed of the own-vehicle M, an acceleration sensor that detects the acceleration thereof, a yaw rate sensor that detects an angular speed thereof about the vertical axis, an orientation sensor that detects the orientation of the own-vehicle M, or the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory.

The GNSS receiver 51 specifies the position of the own-vehicle M on the basis of signals received from GNSS satellites. The position of the own-vehicle M may also be specified or supplemented by an inertial navigation system (INS) using the output of the vehicle sensors 40.

The navigation HMI 52 includes a display device, a speaker, a touch panel, a key, or the like. The navigation HMI 52 may be partly or wholly shared with the HMI 30 described above.

For example, the route determiner 53 determines a route from the position of the own-vehicle M specified by the GNSS receiver 51 (or an arbitrary input position) to a destination input by the occupant (hereinafter referred to as an on-map route) using the navigation HMI 52 by referring to the first map information 54. The first map information 54 is, for example, information representing shapes of roads by links indicating roads and nodes connected by the links. The first map information 54 may include curvatures of roads, point of interest (POI) information, or the like. The on-map route is output to the MPU 60.

The navigation device 50 may also perform route guidance using the navigation HMI 52 on the basis of the on-map route. The navigation device 50 may be realized, for example, by a function of a terminal device such as a smartphone or a tablet possessed by the occupant. The navigation device 50 may also transmit the current position and the destination to a navigation server via the communication device 20 and acquire a route equivalent to the on-map route from the navigation server.

The MPU 60 includes, for example, a recommended lane determiner 61 and holds second map information 62 in a storage device such as an HDD or a flash memory. The recommended lane determiner 61 divides the on-map route provided from the navigation device 50 into a plurality of blocks (for example, into blocks each 100 meters long in the direction in which the vehicle travels) and determines a recommended lane for each block by referring to the second map information 62. The recommended lane determiner 61 determines the number of the lane from the left in which to travel. When there is a branch point on the on-map route, the recommended lane determiner 61 determines a recommended lane such that the own-vehicle M can travel on a reasonable route for proceeding to the branch destination.

The second map information 62 is map information with higher accuracy than the first map information 54. The second map information 62 includes, for example, information of the centers of lanes, information of the boundaries of lanes, or information of the types of lanes. The second map information 62 may also include road information, traffic regulation information, address information (addresses/postal codes), facility information, telephone number information, or the like. The second map information 62 may be updated as needed by the communication device 20 communicating with another device.

The driving operators 80 include, for example, an accelerator pedal, a brake pedal, a shift lever, a steering wheel, a different shaped steering member, a joystick, and other operators. Sensors for detecting the amounts of operation or the presence or absence of operation are attached to the driving operators 80. Results of the detection are output to the automated driving control device 100 or some or all of the travel driving force output device 200, the brake device 210, and the steering device 220.

The automated driving control device 100 includes, for example, a first controller 120, a second controller 160, and a storage 180. Each of the first controller 120 and the second controller 160 is realized, for example, by a processor such as a central processing unit (CPU) executing a program (software). Some or all of these components may be realized by hardware (including circuitry) such as large scale integration (LSI), an application specific integrated circuit (ASIC), a field-programmable gate array (FPGA), or a graphics processing unit (GPU) or may be realized by hardware and software in cooperation. The program may be stored in the storage 180 in the automated driving control device 100 in advance or may be stored in a detachable storage medium such as a DVD or a CD-ROM and then installed in the storage 180 by inserting the storage medium into a drive device.

The storage 180 is realized by an HDD, a flash memory, an electrically erasable programmable read only memory (EEPROM), a read only memory (ROM), a random access memory (RAM), or the like. The storage 180 stores, for example, a program that is read and executed by a processor.

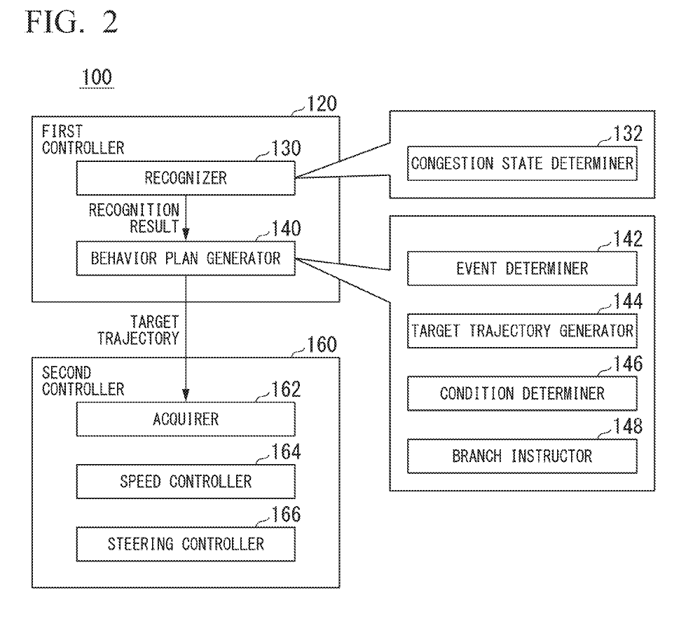

FIG. 2 is a functional configuration diagram of the first controller 120 and the second controller 160. The first controller 120 includes, for example, a recognizer 130 and a behavior plan generator 140. For example, the first controller 120 realizes a function based on artificial intelligence (AI) and a function based on a previously given model in parallel. For example, the function of “recognizing an intersection” is realized by performing recognition of an intersection through deep learning or the like and recognition based on previously given conditions (presence of a signal, a road sign, or the like for which pattern matching is possible) in parallel and evaluating both comprehensively through scoring. This guarantees the reliability of automated driving.

The recognizer 130 recognizes states of an object near the own-vehicle M such as the position, speed and acceleration thereof on the basis of information input from the camera 10, the radar device 12, and the finder 14 via the object recognition device 16. The position of the object is recognized, for example, as a position in an absolute coordinate system whose origin is at a representative point on the own-vehicle M (such as the center of gravity or the center of a drive shaft thereof), and used for control. The position of the object may be represented by a representative point on the object such as the center of gravity or a corner thereof or may be represented by an expressed region. The “states” of the object may include an acceleration or jerk of the object or a “behavior state” thereof (for example, whether or not the object is changing or is going to change lanes).

The recognizer 130 recognizes, for example, a lane in which the own-vehicle M is traveling (an own lane). For example, the recognizer 130 recognizes the own lane, for example, by comparing a pattern of road lane lines (for example, an arrangement of solid and broken lines) obtained from the second map information 62 with a pattern of road lane lines near the own-vehicle M recognized from an image captured by the camera 10. The recognizer 130 may recognize the own lane by recognizing travel boundaries (road boundaries) including road lane lines, road shoulders, curbs, a median strip, guardrails, or the like, without being limited to road lane lines. This recognition may be performed taking into consideration a position of the own-vehicle M acquired from the navigation device 50 or a result of processing by the INS. The recognizer 130 recognizes temporary stop lines, obstacles, red lights, toll gates, and other road phenomena.

When recognizing the own lane, the recognizer 130 recognizes the position or attitude of the own-vehicle M with respect to the own lane. For example, the recognizer 130 may recognize both a deviation from the lane center of the reference point of the own-vehicle M and an angle formed by the travel direction of the own-vehicle M relative to an extension line of the lane center as the relative position and attitude of the own-vehicle M with respect to the own lane. Alternatively, the recognizer 130 may recognize the position of the reference point of the own-vehicle M with respect to one of the sides of the own lane (a road lane line or a road boundary) or the like as the relative position of the own-vehicle M with respect to the own lane.

The recognizer 130 includes, for example, a congestion state determiner 132. Based on the recognition result described above, the congestion state determiner 132 determines whether or not a plurality of other vehicles present ahead of the own-vehicle M (hereinafter referred to as “preceding vehicles”) are in a congested state in the own lane in which the own-vehicle M is traveling. For example, the congestion state determiner 132 determines whether or not there are, for example, at least a predetermined number of preceding vehicles whose speed is less than a predetermined speed and which are continuous with a predetermined inter-vehicle distance or less. The predetermined speed is, for example, a speed of about 0 km/h or several to several tens of km/h at which the vehicle can be regarded as stopping or traveling slowly. When there are at least the predetermined number of preceding vehicles whose speed is less than the predetermined speed and which are continuous with the predetermined inter-vehicle distance or less, the congestion state determiner 132 determines that the preceding vehicles are in a congested state.

The behavior plan generator 140 includes, for example, an event determiner 142, a target trajectory generator 144, a condition determiner 146, and a branch instructor 148. The event determiner 142 determines an automated driving event in the route in which the recommended lane has been determined. The event is information defining the travel mode of the own-vehicle M.

Events include, for example, a constant-speed travel event which is an event of causing the own-vehicle M to travel in the same lane at a constant speed, a following travel event which is an event of causing the own-vehicle M to follow a preceding vehicle present ahead of the own-vehicle M, a lane change event which is an event of causing the own-vehicle M to change lanes from the own lane to an adjacent lane, a branching event which is an event of causing the own-vehicle M to branch to a target lane at a branch point of a road, a merging event which is an event of causing the own-vehicle M to merge into a main line at a merge point, and a takeover event which is an event of terminating automated driving and switching to manual driving. Here, “following” a preceding vehicle indicates, for example, a travel mode which keeps the relative distance (inter-vehicle distance) between the own-vehicle M and the preceding vehicle constant. The events may also include, for example, an overtaking event which is an event of causing the own-vehicle M to temporarily change lanes to an adjacent lane to overtake a preceding vehicle in the adjacent lane and then to change lanes to the original lane again, and an avoidance event which is an event of causing the own-vehicle M to perform at least one of braking and steering to avoid approaching an obstacle.

The event determiner 142 may change an already determined event to another event or determine a new event according to a surrounding situation that the recognizer 130 recognizes while the own-vehicle M is traveling.

The target trajectory generator 144 generates a future target trajectory such that the own-vehicle M travels basically in the recommended lane determined by the recommended lane determiner 61 and further travels automatically (without depending on the driver's operation) in a travel mode defined by the event to cope with the surrounding situation while the own-vehicle M is traveling in the recommended lane. The target trajectory includes, for example, position elements that define the positions of the own-vehicle M in the future and speed elements that define the speeds or the like of the own-vehicle M in the future.

For example, the target trajectory generator 144 determines a plurality of points (trajectory points) which are to be sequentially reached by the own-vehicle M as position elements of the target trajectory. The trajectory points are points to be reached by the own-vehicle M at intervals of a predetermined travel distance (for example, at intervals of about several meters). The predetermined travel distance may be calculated, for example, by a road distance measured while traveling along the route.

The target trajectory generator 144 determines a target speed and a target acceleration for each predetermined sampling time (for example, every several tenths of a second) as speed elements of the target trajectory. The trajectory points may be positions to be reached by the own-vehicle M at intervals of the predetermined sampling time. In this case, the target speed and the target acceleration are determined by the sampling time and the interval between the trajectory points. The target trajectory generator 144 outputs information indicating the generated target trajectory to the second controller 160.

The condition determiner 146 determines whether or not a predetermined condition is satisfied. The predetermined condition includes that the own-vehicle be scheduled to move from the own lane to an added lane to travel along a target route constituted by the recommended lanes described above (condition 1) and that the congestion state determiner 132 have determined that the preceding vehicles are in a congested state (condition 2). When both the conditions 1 and 2 are satisfied, the condition determiner 146 determines that the predetermined condition is satisfied. The added lane is a lane that is added with an increase in the number of lanes, for example, a right-turn only lane. For example, the condition determiner 146 performs the determination process when the own-vehicle M has reached a predetermined distance (for example, 2 km) to a branching intersection.

When the condition determiner 146 has determined that the predetermined condition is satisfied, the branch instructor 148 generates an instruction to cause the own-vehicle M to travel toward the added lane from the own lane at a position before the start position of the added lane and outputs the instruction to the target trajectory generator 144. Upon receiving this instruction, the target trajectory generator 144 generates, for example, a target trajectory for traveling toward the added lane from the own lane at a position before the start position of the added lane from the current position of the own-vehicle M. By doing so, when the condition determiner 146 has determined that the predetermined condition is satisfied, the target trajectory generator 144 can generate a target trajectory for moving out of the congestion of preceding vehicles at a position before the start position of the added lane in the recommended lane and moving to the added lane from the own lane.

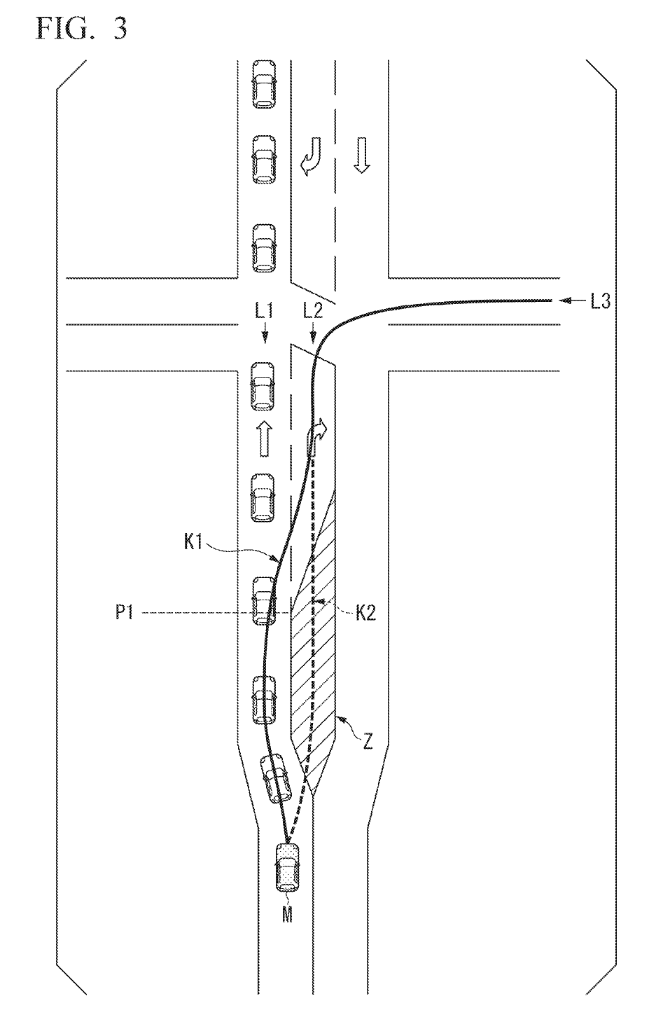

An exemplary scenario in which the predetermined condition is established in the first embodiment will be described below with reference to FIG. 3. FIG. 3 is a diagram illustrating an exemplary scenario in which the predetermined condition is established in the first embodiment. In FIG. 3, lane L1 is the own lane of the own-vehicle M, lane L2 is an added lane that branches off from the lane L1, and lane L3 is a lane into which to turn right from the lane L2. A zebra zone Z is provided behind the added lane L2. The route of the own-vehicle M determined by the route determiner 53 is a route of making a right turn from the lane L1 at an intersection shown in FIG. 3 and entering the lane L3. The recommended lanes of the own-vehicle M determined by the recommended lane determiner 61 include the lane L1 up to the point P1, the added lane L2 from the point P1, and the lane L3 after the right turn. Under these conditions, a target trajectory in the case where the predetermined condition is not established is, for example, target trajectory K1 shown in FIG. 3. The point P1 is a point at which the added lane L2 starts in the traveling direction of the lane L1.

When the target trajectory K1 described above has been determined as a route of the own-vehicle M, the condition determiner 146 determines that the condition 1 is satisfied. When the congestion state determiner 132 has determined that the preceding vehicles are in a congested state, the condition determiner 146 determines that the condition 2 is satisfied. When the condition determiner 146 has determined that both the conditions 1 and 2 are satisfied before the own-vehicle M passes by the point P1 of the lane L1, the target trajectory generator 144 generates a target trajectory K2 for changing lanes from the lane L1 to the added lane L2 before the point P1 and outputs the target trajectory K2 to the second controller 160.

The second controller 160 controls the travel driving force output device 200, the brake device 210, and the steering device 220 such that the own-vehicle M passes along the target trajectory generated by the target trajectory generator 144 at scheduled times.

The second controller 160 includes, for example, an acquirer 162, a speed controller 164, and a steering controller 166. The second controller 160 and the behavior plan generator 140 are examples of the “driving controller.”

The acquirer 162 acquires information on the target trajectory (trajectory points) generated by the target trajectory generator 144 and stores it in a memory in the storage 180.

The speed controller 164 controls one or both of the travel driving force output device 200 and the brake device 210 on the basis of a speed element (for example, a target speed or a target acceleration) included in the target trajectory stored in the memory.

The steering controller 166 controls the steering device 220 according to a position element (for example, a curvature representing the degree of curvature of the target trajectory) included in the target trajectory stored in the memory.

The processing of the speed controller 164 and the steering controller 166 is realized, for example, by a combination of feedforward control and feedback control. As one example, the steering controller 166 performs the processing by combining feedforward control according to the curvature of the road ahead of the own-vehicle M and feedback control based on deviation from the target trajectory.

The travel driving force output device 200 outputs a travel driving force (torque) required for the vehicle to travel to driving wheels. The travel driving force output device 200 includes, for example, a combination of an internal combustion engine, an electric motor, a transmission, and the like and a power electronic control unit (ECU) that controls them. The power ECU controls the above constituent elements according to information input from the second controller 160 or information input from the driving operators 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to information input from the second controller 160 or information input from the driving operators 80 such that a brake torque corresponding to a braking operation is output to each wheel. The brake device 210 may include, as a backup, a mechanism for transferring a hydraulic pressure generated by an operation of the brake pedal included in the driving operators 80 to the cylinder via a master cylinder. The brake device 210 is not limited to that configured as described above and may be an electronically controlled hydraulic brake device that controls an actuator according to information input from the second controller 160 and transmits the hydraulic pressure of the master cylinder to the cylinder.

The steering device 220 includes, for example, a steering ECU and an electric motor. The electric motor, for example, applies a force to a rack-and-pinion mechanism to change the direction of the steering wheel. The steering ECU drives the electric motor according to information input from the second controller 160 or information input from the driving operators 80 to change the direction of the steering wheel.

### [Process Flow]

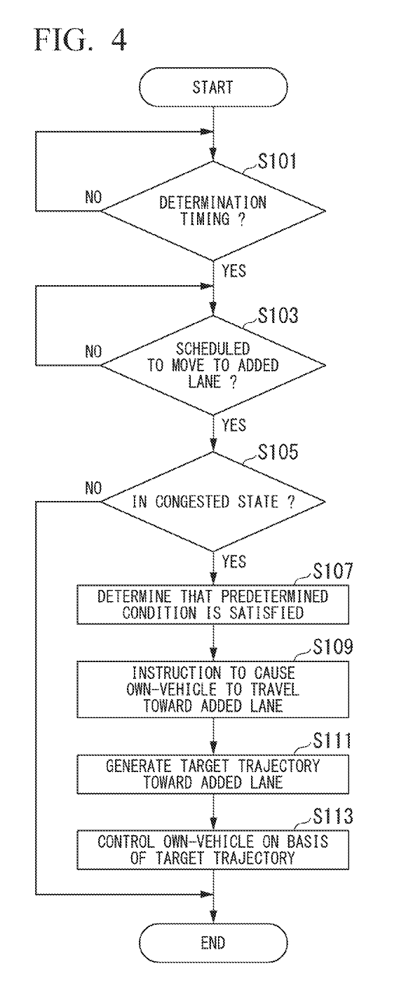

Hereinafter, a flow of a series of processes performed by the automated driving control device 100 of the first embodiment will be described with reference to a flowchart. FIG. 4 is a flowchart showing an example of the flow of the series of processes performed by the automated driving control device 100 of the first embodiment. For example, the process of this flowchart may be repeatedly performed at a predetermined cycle.

First, the condition determiner 146 determines whether or not the determination timing has been reached (step S101). For example, the condition determiner 146 determines that the determination timing has been reached when the traveling position of the own-vehicle M has reached a predetermined distance to a branching intersection. Upon determining that the determination timing has been reached, the condition determiner 146 determines whether or not the own-vehicle M is scheduled to move from the own lane to an added lane to travel along the target route (step S103). Upon determining that the own-vehicle is scheduled to move from the own lane to an added lane, the condition determiner 146 determines whether or not the congestion state determiner 132 has determined that preceding vehicles are in a congested state (step S105). When the congestion state determiner 132 has determined that preceding vehicles are in a congested state, the condition determiner 146 determines that the predetermined condition is satisfied (step S107).

When the condition determiner 146 has determined that the predetermined condition is satisfied, the branch instructor 148 generates an instruction to cause the own-vehicle M to travel toward the added lane and outputs the instruction to the target trajectory generator 144 (step S109). Based on this instruction, the target trajectory generator 144 generates a target trajectory toward the added lane (step S111). Then, the second controller 160 controls the travel of the own-vehicle M such that the own-vehicle M passes along the target trajectory generated by the target trajectory generator 144 at scheduled times (step S113).

According to the first embodiment described above, the congestion state determiner 132 configured to determine whether or not a plurality of preceding vehicles, which are present ahead of the own-vehicle M in the own lane in which the own-vehicle M is traveling, are in a congested state and a driving controller (the second controller 160 and the behavior plan generator 140) configured to control at least steering of the own-vehicle M and to cause the own-vehicle M to travel toward an added lane from the own lane at a position before a start position of the added lane if a condition including that the own-vehicle M be scheduled to move from the own lane to the added lane to travel along the target route and that the congestion state determiner 132 have determined that the preceding vehicles are in a congested state is satisfied are provided and therefore it is possible to realize appropriate traveling according to surrounding traffic situations.

### Second Embodiment

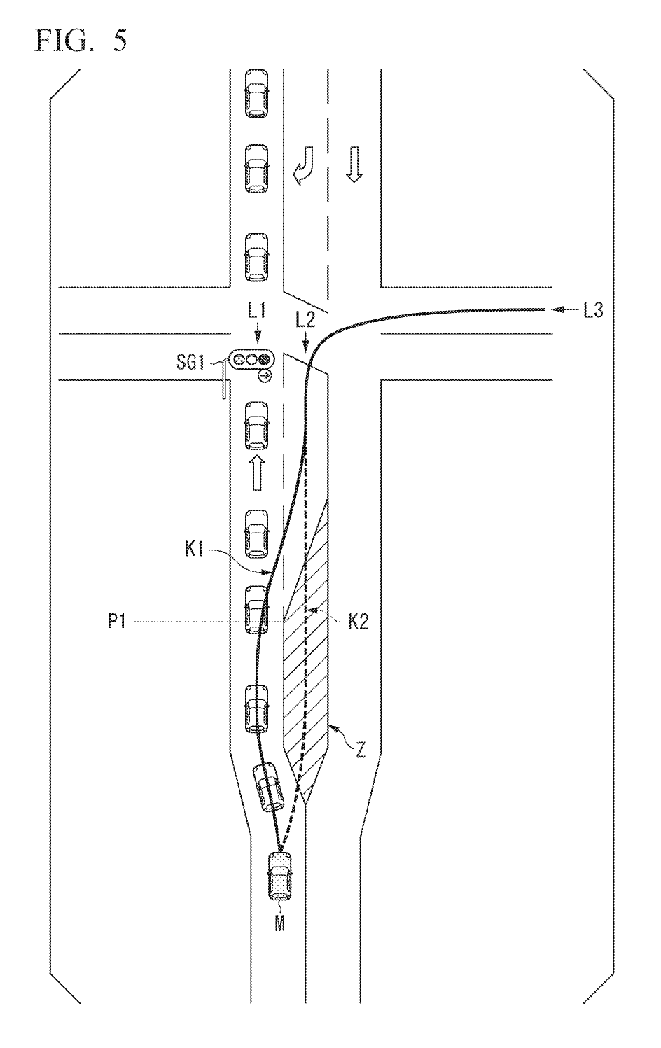

A second embodiment will now be described. In the second embodiment, the predetermined condition further includes that the recognizer 130 have recognized that a traffic signal installed at an intersection relating to the added lane indicates that it is possible to proceed to the travel destination of the added lane (conditions 3). An exemplary scenario in which the predetermined condition is established in the second embodiment will be described below with reference to FIG. 5. FIG. 5 is a diagram illustrating an exemplary scenario in which the predetermined condition is established in the second embodiment. In FIG. 5, a traffic signal SG1 is installed at the intersection relating to the added lane L2. The traffic signal SG1 is also provided with a right turn only light in addition to green, yellow, and red lights. For example, when the recognizer 130 has recognized that the traffic signal SG1 is green or that the right turn only light is green, the condition determiner 146 determines that the condition 3 is satisfied. When at least all of the condition 1, the condition 2, and the condition 3 are established, the condition determiner 146 determines that the predetermined condition is satisfied. When the condition determiner 146 has determined that the predetermined condition is satisfied before the own-vehicle M passes by a point P1 of the lane L1, the branch instructor 148 generates an instruction to cause the own-vehicle M to travel toward the added lane and outputs the instruction to the target trajectory generator 144. The target trajectory generator 144 generates a target trajectory K2 for changing lanes from the lane L1 to the added lane L2 before the point P1 and outputs the target trajectory K2 to the second controller 160.

According to the second embodiment described above, when the condition determiner 146 has determined that the predetermined condition is satisfied, the target trajectory generator 144 can generate a target trajectory for moving out of the congestion of preceding vehicles at a position before the start position of the added lane in the recommended lane and moving to the added lane from the own lane. Therefore, it is possible to avoid situations in which it is not possible to turn right because a straight-ahead lane is congested even though the right turn only light is green.

### Third Embodiment

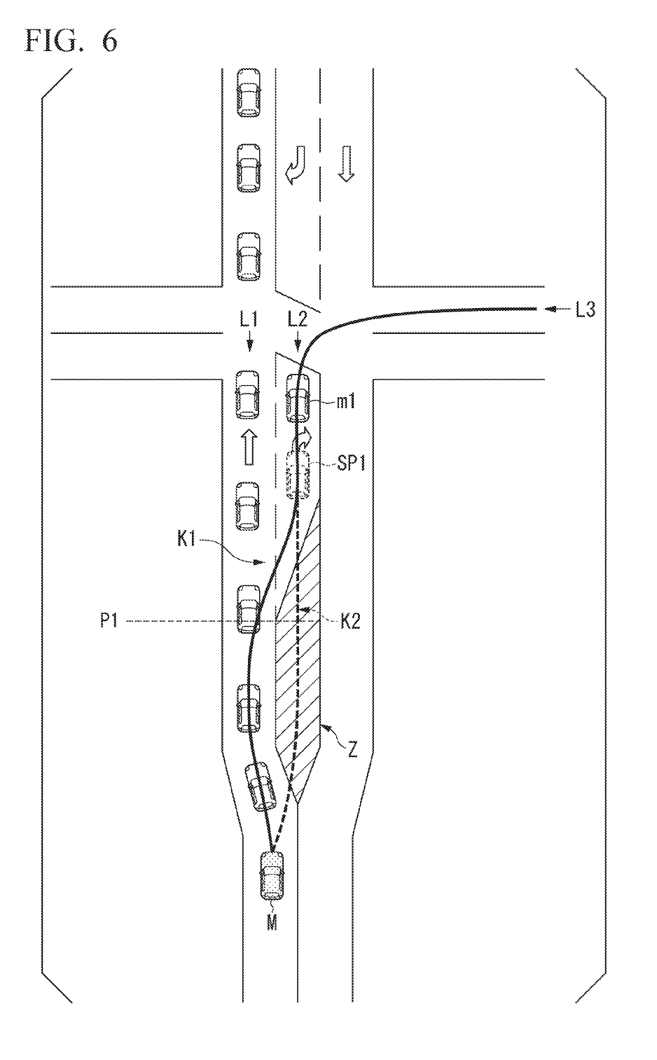

A third embodiment will now be described. In the third embodiment, the predetermined condition further includes that the recognizer 130 have confirmed that the added lane has a space which the own-vehicle M can enter (condition 4). An exemplary scenario in which the predetermined condition is established in the third embodiment will be described below with reference to FIG. 6. FIG. 6 is a diagram illustrating an exemplary scenario in which the predetermined condition is established in the third embodiment. In FIG. 6, another vehicle ml stops in the added lane L2 and the added lane has a space SP1 behind the other vehicle ml where at least the own-vehicle M can stop. For example, when the recognizer 130 has recognized that no other vehicle is present in the added lane L2 or that another vehicle ml is present in the added lane L2, leaving an empty space SP1 where the own-vehicle M can stop, the condition determiner 146 determines that the condition 4 is satisfied. When at least all of the condition 1, the condition 2, and the condition 4 are satisfied, the condition determiner 146 determines that the predetermined condition is satisfied. When the condition determiner 146 has determined that the predetermined condition is satisfied before the own-vehicle M passes by the point P1 of the lane L1, the branch instructor 148 generates an instruction to cause the own-vehicle M to travel toward the added lane and outputs the instruction to the target trajectory generator 144. The target trajectory generator 144 generates a target trajectory K2 for changing lanes from the lane L1 to the added lane L2 before the point P1 and outputs the target trajectory K2 to the second controller 160.

According to the third embodiment described above, when the condition determiner 146 has determined that the predetermined condition is satisfied, the target trajectory generator 144 can generate a target trajectory for moving out of the congestion of preceding vehicles at a position before the start position of the added lane in the recommended lane and moving to the added lane from the own lane such that the own-vehicle M can stop at the empty space in the added lane. Therefore, even when the right turn only light is red, the own-vehicle M can stop in the added lane and wait until the right turn only light turns green.

### Fourth Embodiment

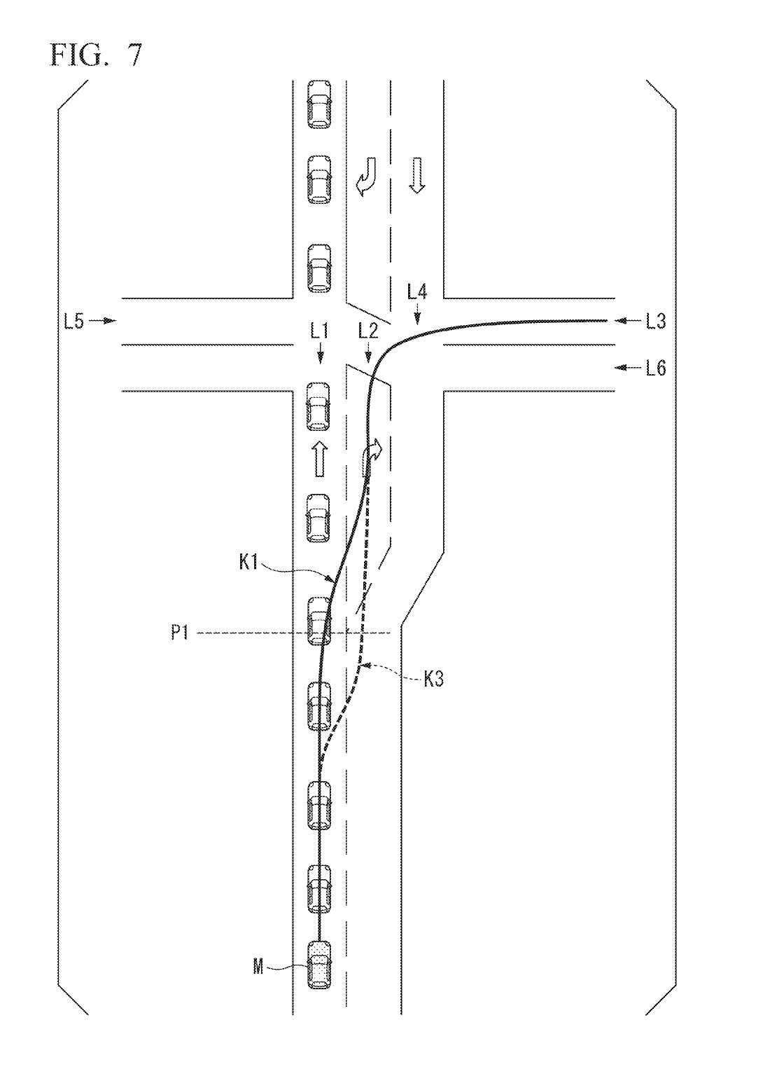

A fourth embodiment will now be described. In the fourth embodiment, the predetermined condition further includes that the recognizer 130 have recognized that there is no oncoming vehicle traveling in the opposite lane extending to the rear side of the added lane (condition 5). An exemplary scenario in which the predetermined condition is established in the fourth embodiment will be described below with reference to FIG. 7. FIG. 7 is a diagram illustrating an exemplary scenario in which the predetermined condition is established in the fourth embodiment. In FIG. 7, lane L4 is the opposite lane of the lane L1, lane L5 is a lane entering the intersection from the left side in the traveling direction of the lane L1, and lane L6 is a lane entering the intersection from the right side in the traveling direction of the lane L1.

For example, when the recognizer 130 has recognized that there is no oncoming vehicle in front of the own-vehicle M in the opposite lane L4, the condition determiner 146 determines that the condition 5 is satisfied. When at least all of the condition 1, the condition 2, and the condition 5 are established, the condition determiner 146 determines that the predetermined condition is satisfied. When the condition determiner 146 has determined that the predetermined condition is satisfied before the own-vehicle M passes by the point P1 of the lane L1, the branch instructor 148 generates an instruction to cause the own-vehicle M to travel toward the added lane from the own lane at a position before the start position of the added lane and outputs the instruction to the target trajectory generator 144. The target trajectory generator 144 generates a target trajectory K3 for changing lanes from the lane L1 to the opposite lane L4 before the point P1 and entering the added lane L2 and outputs the target trajectory K3 to the second controller 160.

According to the fourth embodiment described above, when the condition determiner 146 has determined that the predetermined condition is satisfied, the target trajectory generator 144 can generate a target trajectory for moving out of the congestion of preceding vehicles at a position before the start position of the added lane in the recommended lane and moving to the added lane from the own lane in a situation in which there is no oncoming vehicle. For example, when the traffic signal at the intersection is red or when there is no vehicle turning right from the lane L5 or turning left from the lane L6 to enter the opposite lane L4, there is a time during which there is no oncoming vehicle traveling in the opposite lane L4. The fourth embodiment is particularly effective in such a scenario.

### Fifth Embodiment

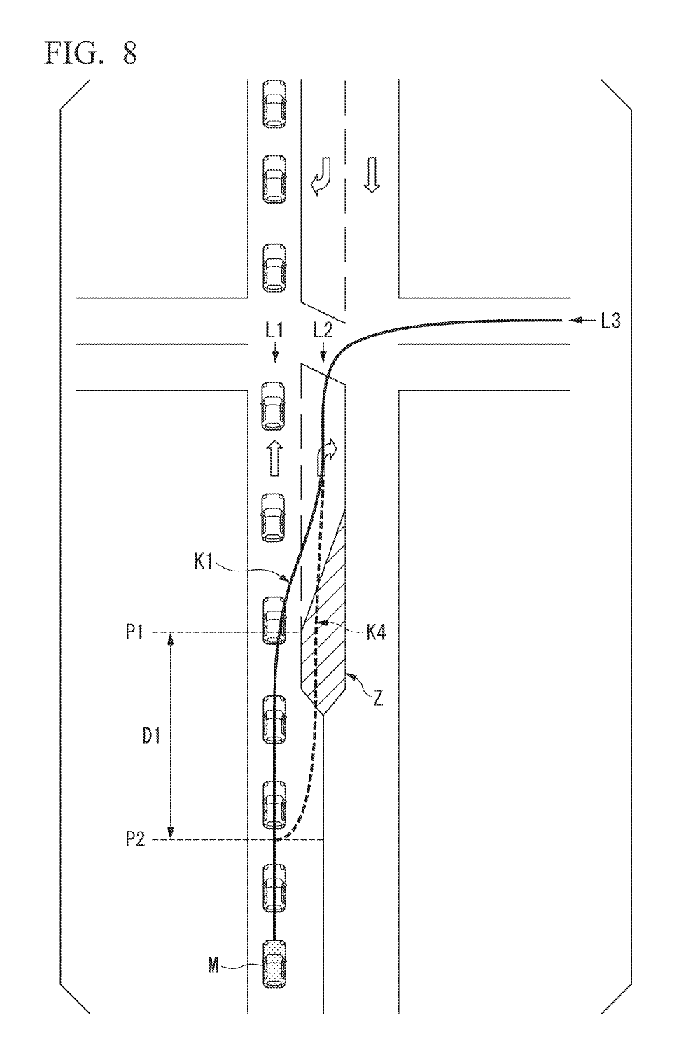

A fifth embodiment will now be described. In the fifth embodiment, the predetermined condition further includes that the own-vehicle M have arrived at a position (point P2) from which the distance to the start position (point P1) of the added lane L2 is equal to or less than a threshold value (condition 6). An exemplary scenario in which the predetermined condition is established in the fifth embodiment will be described below with reference to FIG. 8. FIG. 8 is a diagram illustrating an exemplary scenario in which the predetermined condition is established in the fifth embodiment. In FIG. 8, the point P2 is behind the point P1 by a distance D1 (the threshold value) in the traveling direction of the lane L1. The condition determiner 146 determines that the condition 6 is satisfied, for example, when the recognizer 130 has recognized that the own-vehicle M has arrived at the point P2. The condition determiner 146 may also determine that the condition 6 is satisfied when the navigation device 50 has determined that the own-vehicle M has arrived at the point P2 on the basis of the position of the own-vehicle M specified by the GNSS receiver 51. When at least all of the condition 1, the condition 2, and the condition 6 are established, the condition determiner 146 determines that the predetermined condition is satisfied.

When the condition determiner 146 has determined that the predetermined condition is satisfied before the own-vehicle M passes by the point P1 of the lane L1, the branch instructor 148 generates an instruction to cause the own-vehicle M to travel toward the added lane from the own lane at a position before the start position of the added lane and outputs the instruction to the target trajectory generator 144. The target trajectory generator 144 generates one of the following target trajectories and outputs the target trajectory to the second controller 160. For example, as shown in FIG. 8, when the lane L1 is wide such that the own-vehicle M can overtake a preceding vehicle in the lane L1, the target trajectory generator 144 generates a target trajectory K4 for overtaking the preceding vehicle in the lane L1 and entering a zebra zone Z and then entering the added lane L2. For example, when crossing of the center line to overtake is prohibited, the target trajectory generator 144 may generate a target trajectory for traveling behind the preceding vehicle in the lane L1 until the start position of the zebra zone Z is reached and entering the zebra zone Z and then entering the added lane L2. When there is no zebra zone Z, the target trajectory generator 144 may generate a target trajectory for entering the added lane L2 after traveling in the opposite lane. In the last case, the target trajectory generator 144 may be configured to generate the trajectory when at least the conditions 1, 2, 4, and 6 are established before the own-vehicle M passes by the point P1 of the lane L1.

According to the fifth embodiment explained above, upon approaching the start point of the added lane L2, it is possible to move out of the congestion of preceding vehicles and move to the added lane from the own lane.

### [Hardware Configuration]

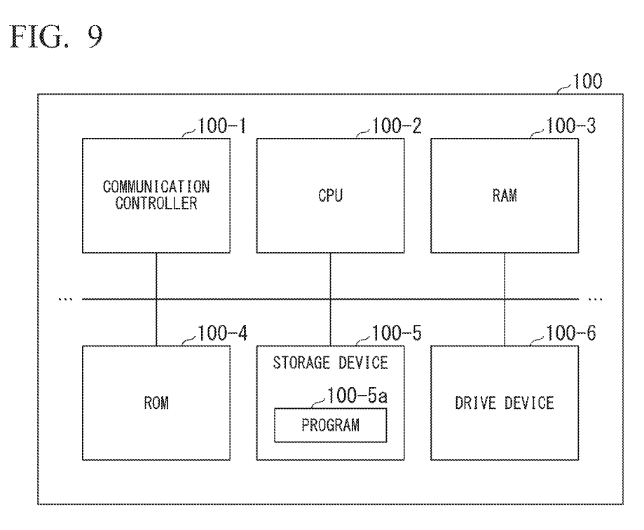

FIG. 9 is a diagram showing an example of the hardware configuration of the automated driving control device 100 according to an embodiment. As shown, the automated driving control device 100 is configured such that a communication controller 100-1, a CPU 100-2, a RAM 100-3 used as a working memory, a ROM 100-4 storing a boot program or the like, a storage device 100-5 such as a flash memory or an HDD, a drive device 100-6, or the like are connected to each other via an internal bus or a dedicated communication line. The communication controller 100-1 performs communication with components other than the automated driving control device 100. The storage device 100-5 stores a program 100-5a to be executed by the CPU 100-2. This program is loaded in the RAM 100-3 by a direct memory access (DMA) controller (not shown) or the like and then executed by the CPU 100-2. Thereby, some or all of the first controller 120 and the second controller 160 are realized.

The embodiments described above can be expressed as follows.

A vehicle control device including:

a storage device configured to store a program; and

a processor,

wherein the processor is configured to execute the program stored in the storage device to:

determine whether or not a plurality of preceding vehicles, which are present ahead of an own-vehicle in an own lane in which the own-vehicle is traveling, are in a congested state on the basis of a result of recognition by a recognizer configured to recognize at least one of a surrounding environment of the own-vehicle or a traveling speed of the own-vehicle; and

control at least steering of the own-vehicle such that the own-vehicle travels toward an added lane from the own lane at a position before a start position of the added lane if a condition including that the own-vehicle be scheduled to move from the own lane to the added lane to travel along a target route and that it have been determined that the preceding vehicles are in a congested state is satisfied.

Although the modes for carrying out the present invention have been described above by way of embodiments, the present invention is not limited to these embodiments at all and various modifications and substitutions can be made without departing from the gist of the present invention.

For example, whether or not the predetermined condition is satisfied may be determined by combining the embodiments described above according to the surrounding situation of the own-vehicle.

What is claimed is:

1. A vehicle control device comprising:
a congestion state determiner configured to determine whether or not a plurality of preceding vehicles, which are present ahead of an own-vehicle in an own lane in which the own-vehicle is traveling, are in a congested state on the basis of a result of recognition by a recognizer configured to recognize at least one of a surrounding environment of the own-vehicle or a traveling speed of the own-vehicle; and
a driving controller configured to control at least steering of the own-vehicle and to cause the own-vehicle to travel toward an added lane from the own lane at a position before a start position of the added lane if a condition including that the own-vehicle be scheduled to move from the own lane to the added lane to travel along a target route and that the congestion state determiner have determined that the preceding vehicles are in a congested state is satisfied.

2. The vehicle control device according to claim 1, wherein the condition further includes that the recognizer configured to recognize a surrounding situation of the own-vehicle have recognized that a traffic signal installed at an intersection relating to the added lane indicates that it is possible to proceed to a travel destination of the added lane.

3. The vehicle control device according to claim 1, wherein the condition further includes that the recognizer configured to recognize a surrounding situation of the own-vehicle have recognized that the added lane has a space which the own-vehicle can enter.

4. The vehicle control device according to claim 1, wherein the condition further includes that the recognizer configured to recognize a surrounding situation of the own-vehicle have recognized that there is no oncoming vehicle traveling in an opposite lane extending to a rear side of the added lane.

5. The vehicle control device according to claim 1, wherein the condition further includes that the own-vehicle have arrived at a position from which a distance to the start position is equal to or less than a predetermined distance.

6. A vehicle control method comprising:
an in-vehicle computer determining whether or not a plurality of preceding vehicles, which are present ahead of an own-vehicle in an own lane in which the own-vehicle is traveling, are in a congested state on the basis of a result of recognition by a recognizer configured to recognize at least one of a surrounding environment of the own-vehicle or a traveling speed of the own-vehicle; and
causing the own-vehicle to travel toward an added lane from the own lane at a position before a start position of the added lane if a condition including that the own-vehicle be scheduled to move from the own lane to the added lane to travel along a target route and that it have been determined that the preceding vehicles are in a congested state is satisfied.

7. A computer readable non-transitory storage medium storing a program causing an in-vehicle computer to:
determine whether or not a plurality of preceding vehicles, which are present ahead of an own-vehicle in an own lane in which the own-vehicle is traveling, are in a congested state on the basis of a result of recognition by a recognizer configured to recognize at least one of a surrounding environment of the own-vehicle or a traveling speed of the own-vehicle; and
cause the own-vehicle to travel toward an added lane from the own lane at a position before a start position of the added lane if a condition including that the own-vehicle be scheduled to move from the own lane to the added lane to travel along a target route and that it have been determined that the preceding vehicles are in a congested state is satisfied.
